(19) United States
(12) Patent Application Publication
(10) Pub. No.: US 2004/0024106 A1
(43) Pub. Date: Feb. 5, 2004

(54) Polymer resin for ion beam or ion injection treatment to give surface conductiveness

(76) Inventor: Kwang-Seup Kim, Seoul (KR)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/297,137

(22) PCT Filed: Sep. 27, 2001
(86) PCT No.: PCT/KR01/01624

(30) Foreign Application Priority Data
Apr. 3, 2001 (KR) 2001/17751

(51) Int. Cl. C08L 1/00

(52) U.S. Cl. 524/494

(57) ABSTRACT

The present invention relates to a resin composition suitable for an ion beam, ion plasma or ion implanation treatment. The resin is consists of one or more components selected from polyphenylene oxide, polycarbonate, polybuthylene terephthalate, polysulfone, polyethylene terephthalate, polyethersulfone, polyphenylenesulfide, polystyrene, acrylonitrile-butadiene-styrene copolymer, polyetherimide, polyamide, polymethylmethacrylate, polyacetal, polyethylene, polyropylene, styrene-butadiene rubber, ethylene-propylene rubber and EPDM rubber. So this resin having a proper conductivity is very useful for a packing material of cellular phone, computer monitor, liquid crystal display, and a IC film or tube.

### TECHNICAL FIELD

The present invention relates to a resin composition for an ion beam, ion plasma or ion implantation treatment, and more particularly, to a resin composition to shield electromagnetic waves and provide the conductivity for a semiconductor carriage tape or a tube, the resin composition having a high heat-resistant temperature, an excellent dimension stability and durability for ion beam, ion implantation treatment or ion sputtering through a vacuum plasma.

### BACKGROUND ART

Conventionally, in order to allow a polymer to have an electrical conductivity, there are used methods of coating or compounding the polymer with a carbon fiber, a conductive carbon black or a conductive metal powder of silver, gold, nickel, copper, iron, aluminum or stainless steel, etc., by a spraying or dipping.

However, these methods have a drawback of environmental contamination due to dust particles or organic solvents used in the coating. Further, in order to process these organic solvents, it is necessary to invest a vast cost for processing waste water.

Moreover, in order to allow the polymer the electrical conductivity using a plasma deposition method or an ion implantation method, a conductive material should be deposited or an ion should be implanted into the polymer under an accelerated voltage. These methods, however, cause problems such as dimension deformation or durability weakness of a finished article, resulting in the difficulty of the commercialization.

### DISCLOSURE OF INVENTION

Accordingly, it is an object of the invention to resolve the aforementioned problems and to provide a polymer resin composition proper for an ion deposition through an ion beam, ion implantation treatment or vacuum plasma and which has a high heat-resistant temperature property, a good dimension stability and an excellent durability.

To accomplish the above object, there is a provided a resin composition proper for ion beam or ion implantation treatment. The resin composition is made of one or more component selected from a group consisting of a plyphenylenoxide or polyphenylenether (PTO), polycarbonate (PC), polybuthyleneterephthalate (PBT), polysulfone (PSU), polyethyleneterephthalate (PET), polyethersulfone (PES), polyphenylenesulfide (PPS), polystylene (PS), acrylo-butadiene-stylene co-polymer (ABS), polyetherimide (PEI), polyamide (PA), polymethylmetaacrylate (PMMA), acethal resin (POM), polyethylene (PE), polyropylene (PP), stylene-butadiene rubber (SBR), ethylene-propylene rubber (EPR), EPDM rubber (ethylene-propylene-diene rubber (EPDM).

The inventor classifies constituents of the resin compositions according to the present invention into several groups to perform several experiments.

### BEST MODE FOR CARRYING OUT THE INVENTION

1) Group I (PPO, PC, PEI, PSU, PES, PPS)

Group I includes resin constituents basically having a heat transformation temperature of 100° C., for instance, PPO, PC, PEI, PSU, PES and PES. These resin constituents may be used in a single type or a composite type. However, while moldability, heat deformation temperature and dimension stability are considered, inorganic filler such as fiber glass, mica, talc, etc. can be included in the group I if necessary.

Also, in case where the PPO constituent is selected as main component and the PS resin is added to a resin composition of the present invention as an additive, the moldability of the resin composition is substantially enhanced. At this time, it is desirous to add the PS resin by an amount of 10% and more by weight.

In case where the PSU constituent is selected as main component and the PC is contained in a resin composition by an amount of 30% by weight, not only the moldability of the resin composition is enhanced but the stability in the heat deformation temperature and dimension is not degenerated.

In case where the PC constituent is selected as main component and fiber glass is contained in a resin composition by an amount of 20-30% by weight, it enables to fabricate a product having an outstanding performance in the heat-resistant temperature and dimension stability.

The resin constituents of the group I in constituents of a resin composition according to the present invention, can be used in the form of a single type or a composite type. Although they are used in such the manners, if 1-40 wt % fiber glass and 1-40 wt % inorganic filler such as mica, talc, etc. are contained in the resin composition, it is possible to fabricate the resin composition proper in being provided the conductivity through an ion beam or ion implantation method having more outstanding dimension stability.

Further, the resins of the group I in the resin composition according to the present invention may be properly used in fields where high heat-resistant temperature is requested. In other words, when an ion beam or ion implantation method is used so as to provide the conductivity, a surface resistance of 10E9Ω·Cm or less is requested and thus surface temperature of the resin polymer is elevated up to 120° C. or more, these resins can be properly used. Especially, these resins are proper in fabricating products such as a semiconductor chip tray, a semiconductor handler, etc. where a process temperature of 120° C. and more is necessary.

Table 1 shows experimental results related to heat resistant property, post-injection ion treatment and post-baking dimension deformation property when the resins of the group I is used to fabricate resin compositions of the present invention in a single type or a mixing type.

TABLE 1

| | PPO + | | | | | PSU + | | | PPS + | | PPS + |
|---|---|---|---|---|---|---|---|---|---|---|---|
| Kind of | PS | | | | | PC | | | PPO | | PPO |
| Resin | Mixing | PPO | PSU | PC | PEI | Mixing | PES | PPS | Mixing | PP | Mixing |
| Amount of | 30 | 0 | 20 | 30 | 25 | 25 | 30 | 40 | 30 | 15 | 30 |
| fiber glass | | | | | | | | | | | |
| Amount of | 10 | 0 | 15 | 5 | 5 | 10 | 5 | 5 | 10 | 30 | 10 |
| mica (wt %) | | | | | | | | | | | |
| Heat-resistant | 170 | 160 | 180 | 145 | 210 | 160 | 200 | 260 | 250 | 143 | 250 |
| temperature | | | | | | | | | | | |
| (° C.) | | | | | | | | | | | |
| Post-injection | 315.1 | 315.2 | 315.2 | 315.2 | 315.2 | 315.15 | 315.1 | 314.9 | 315.0 | 314.9 | 315.0 |
| length (mm) | | | | | | | | | | | |
| Post-ion | 315.0 | 314.9 | 315.1 | 315.05 | 315.0 | 315.0 | 315.0 | 314.8 | 314.85 | 314.6 | 314.85 |
| treatment or | | | | | | | | | | | |
| post-baking | | | | | | | | | | | |
| Dimension | 0.1 | 0.3 | 0.1 | 0.15 | 0.2 | 0.15 | 0.1 | 0.1 | 0.15 | 0.4 | 0.15 |
| variation (mm) | | | | | | | | | | | |

*Standard is length of a mold for extrusion molding: 315.0 ± 0.3 mm (Standard is a long axis direction of a semiconductor chip tray)
*Baking temperature: PC, PP: 120° C., PPO + PS, PSU + PC: 150° C., PEI, PES, PPS, PPS + PPO): 190° C.

In the resin composition according to the present invention, especially the PC among the resin constituents of the group I extrudes in the form of film of less than 2 mm and is provided the conductivity using an ion deposition through an ion beam, ion implantation or vacuum plasma treatment. Thus, they are properly used in semiconductor packaging material and products in which the conductivity is requested.

2) Group II (PBT, PA, PE, PP)

Group II includes resin constituents of PBT, PA, PE and PP. These resin constituents are crystalline resins and they may be used in a single type or a composite type mixed with the resin constituents of the group I.

In the resin compositions according to the present invention, the resin constituents of the group II is considerably low in the dimension stability compared with those of the group I. Through various experiments, it is confirmed that the resin constituents of the group II can be effectively used to fabricate a composite type resin composition by mixing them with the resin constituents of the group I. In other words, mixing of PC and PBT, mixing of PBT and ABS, mixing of PPO and PA and mixing of PPO, PS and PE elevate the heat-resistant temperature during use. Especially, mixing of PE enables to perform a smooth extrusion molding and it shows an excellent extruding moldability in a PPO blend product.

In the meanwhile, in case of PE and PP, in order to stabilize the beat deformation temperature and the molding contraction rate, they are mixed with a resin acting as impact reinforcing material to form a composite resin composition or they are mixed with an inorganic filler such as talc, mica, etc. to form a composite resin composition. As a result, it is confirmed that the composite resin composition has an excellent heat-resistant temperature and molding contraction rate.

Also, the resin constituents of the group II can be extruded in the form of film of less than 2 mm thick. The PE and PP can be used in the form of film having heat-resistant temperature of 100° C. or less, preferably 70° C. or less.

Table 2 shows measurement results of molding contradiction rate and heat-resistant temperature property when resin compositions are fabricated using the resin constituents of the group II in a single type or a mixed type with the resin constituents of the group I.

TABLE 2

| | | Molding | Heat-resistant |
|---|---|---|---|
| Kind of | Mixing | contraction | temperature |
| resins | percentage | rate | (° C.) |
| PBT | 0% | 0.17-0.23% | 150 |
| PG/PBT | PBT 30% | 0.04-0.08% | 125 |
| | Talc 20% | | |
| PA | 0% | 0.17-0.20% | 240 |
| PPO/PA | PA30% | 0.7-0.9% | 185 |
| PE | 0% | 0.20-0.24% | 81 |
| PE + mica | Mica 20% | 0.15% | 95 |
| PP | 0% | 0.16% | 120 |
| PP + Talc + | Talc 10% | 0.08% | 115 |
| EPR | EPR 30% | | |

3) Group III (ABS, PS, PET, PMMA, POM, PE, PP, PC)

Group III includes resin constituents consisting of ABS, PS, PET, PMMA, POM, PE, PP and PC. These resin constituents can be extruded in the form of film of 2 mm thick or less and especially PET, PS, PMMA, POM, PP AND PE can be used as packaging material of semiconductor devices.

The resin constituents of the group III in the resin compositions of the present invention can be mainly used in fabricating conductive films which request relatively low heat-resistant temperature. In case where the resin constituents of the group III are used for the fabrication of such the conductive films, in order to protect main elements such as ion light source of an ion deposition equipment using an ion beam treatment, ion implantation method or vacuum plasma, it is desirous to use an additive having a total content of 3,000 ppm or less, preferably 1,500 ppm or less.

Although such an additive is used, it is possible to fabricate a transparent film type product having a muddy degree (ASTM D1003) of 10% or less. Especially, resin constituents of POM, PMMA, PS, PET, PC and PP enable to fabricate high transparent film (light transmittance of 95% and more). Also, resin constituents of POM, PMMA, PS, PC show an excellent property as material for packaging film and tube and especially PC shows an excellent property in the heat-resistant temperature and bending elasticity.

In the resin compositions of the present invention, various additives may be added to the resin constituents of the groups I, II and III in order to prevent thermal decomposition of the resin constituents during injection molding or extrusion molding. For instance, antioxidant, heat stabilizer, ultraviolet stabilizer, processing aids, etc. can be used as the additives.

However, when these additives are added to the resin compositions in a large amount, the additives are moved into the surface of the resin composition during ion deposition through a vacuum plasma and thus an energy source unit and the inside of a vacuum chamber may be contaminated due to these additives. Accordingly, it is desirous that a total amount of the additives is 3,000 ppm or less, most preferably, 1,000 ppm or less.

4) Inorganic Filler

(1) Fiber Glass

Fiber glass is used as inorganic filler in the resin compositions of the present invention. Specifically, fiber glasses having 20 μm or less in diameter and 1 inch in length in the shape of needle, single piece or sphere can be used in a single type having one kind of diameter, length and shape or a composite type having at least two kinds of diameter, length and shapes. Fiber glass has a function to provide dimension stability. Therefore, it is more preferable to use those having a diameter ranged from 3 μm to 10 μm so as to perform such the dimension stability function. Also, in order to remove the directionality in the surface of the fiber glass and the directionality of the fiber glass itself, milled glass fiber, chopped glass fiber or glass flake can be used in an amount ranged from 0.01% by weight to 50% by weight. Especially, when the milled glass fiber or the chopped glass fiber is used, it helps to obtain an excellent surface, a three-dimensional contraction and a smooth and graceful surface.

(2) Mica

Mica can be used as inorganic filler in the resin compositions of the present invention to stabilize a three-dimension directional contraction rate and a linear thermal expansion coefficient. Its size is preferably a 30 μm, more preferably in a range of 3 μm to 30 μm.

(3) Other Inorganic Reinforcing Aids

In the resin composition of the present invention, conventional inorganic reinforcing aids can be used in a single type or a composite type in order to reinforce heat resistant property, dimension stability, linear thermal expansion coefficient, warpage preventive property, three directions contraction property and other physical properties such as bend elastic rate, tensile strength, etc.

In case where wollastonite that is one kind of calcium-metha-silicate-based compound is used as inorganic reinforcing aids in the resin compositions of the present invention, it is preferable that the wollastonite is 10-19 in aspect composition ratio, 3-25 μm in average diameter and in the shape of needle. It is more preferable that the wollastonite is in an amount of 0.01-30 wt % with respect to a total weight amount.

As inorganic reinforcing aids capable of being used in the present invention, there are talc, calcium-carbonate, asbestos, kaolin, carbon fiber, nylon fiber, vegetable fiber, etc. In case where talc is used, one having an average particle size of 2-4 μm and a single piece phase is preferably used.

In case where carbon fiber is used as inorganic reinforcing aids, since the carbon fiber performs not a function as a provider of the conductivity but a function as filler material, it is possible to use a low leveled, reproduced or chopped carbon fiber.

In the resin compositions of the present invention, it is advantages to use an inorganic reinforcing aids product of which surface is chemically processed to enhance an interfacial adhesive force between polymer and the inorganic reinforcing aids in an amount of 0.01-40 wt % with respect to a total amount of the resin composition.

5) Impact Reinforcing Aids

The resin compositions of the present invention may further comprise impact reinforcing aids. As the impact reinforcing aids, there are styrene-Butadiene Rubber (SBR), ethylene-propylene Rubber (EPR), ethylene-propylene-diene monomer (EPDM).

Especially, external ornament material of hand-held terminals or notebook computers requests very high impact intensity. When about 10% by weight SBR, EPR or EPDM is added, it was confirmed that the impact intensity is considerably reinforced.

Generally, PC/ABS, ABS or PS is mainly used as the external ornament material of hand-held terminals and notebook computers. The below table 3 shows apparently that the impact intensity is very different between the aforementioned rubber component-contained resin composition and the rubber component-not contained resin composition. The present experiments excluded cases of PS used because the external ornament of the PS uses conventionally high impact PS (HIPS).

TABLE 3

| | | | Heat-resistant |
|---|---|---|---|
| | Content of | | temperature |
| Kind of resins | rubber (%) | Impact intensity | (° C.) |
| PC/ABS mixing | 0 | 490 | 90 |
| PC/ABS mixing + SBR | 10 | 735 | 113 |
| ABS | 0 | 160 | 99 |
| ABS + SBR | 25 | 400 | 95 |

In addition to the aforementioned impact reinforcing materials, SBR, EPR or EPDM can be used as the impact reinforcing material and it is especially desirous that SBR be used in order to enhance the interfacial adhesive force.

6) Additives

The resin compositions of the present invention may include additives according to a use. As such the additives, there are coupling agent, first and second anti-Oxidants, UV stabilizer, heat stabilizer, process lubricants and antistatic agents. Also, according to the necessity, carbon black, coloring pigments, coloring dye, nucleus agents and flame retardant agent may be included in the additives.

Through the use of the resin compositions provided by the present invention, it becomes possible to fabricate a product to which the conductivity is given by an ion beam or ion implantation treatment after forming a variety of plastic products using an extrusion molding, blow hole molding or injection molding.

As described above, the resin compositions according to the present invention enables to fabricate various products having excellent properties in view of the heat resistant property, dimension stability and durability even when performing an ion deposition through an ion beam, ion implantation or vacuum plasma treatment. Accordingly, they are applicable to the fabrications of products needing to be provided with the conductivity such as a semiconductor chip tray, a computer monitor, a hand-held terminal, a liquid crystal display carrying packaging paper, a semiconductor chip carrying film and a semiconductor chip carrying tube.

1. A resin composition for ion beam or ion implantation treatment, the resin composition made of one or more component selected from a group consisting of a plyphenylenoxide or polyphenylenether (PTO), polycarbonate (PC), polybuthyleneterephthalate (PBT), polysulfone (PSU), polyethyleneterephthalate (PET), polyethersulfone (PES), polyphenylenesulfide (PPS), polystylene (PS), acrylo-butadiene-stylene co-polymer (ABS), polyetherimide (PEI), polyamide (PA), polymethylmetaacrylate (PMMA), acethal resin (POM), polyethylene (PE), polyropylene (PP), stylene-butadiene rubber (SBR), ethylene-propylene rubber (EPR), EPDM rubber (ethylene-propylene-diene rubber (EPDM).

2. The resin composition of claim 1, further containing 0.01-50 wt % fiber glass.

3. The resin composition of claim 1 or 2, further containing 1-40 wt % filler.

4. The resin composition of claim 2, wherein the fiber glass is 20 μm or less in diameter, 1 inch or less in length, has a shape of needle, single piece and sphere and is used in the form of a single composition and a composite composition.

5. The resin composition of claim 2, wherein the fiber glass is 3-10 μm in diameter.

6. The resin composition of claim 2, wherein the fiber glass is 0.01-50% in an amount by weight and is used in the form of a single composition or a mixed composition selected from a group consisting of a milled glass fiber, a pulverized glass fiber and a glass flake.

7. The resin composition of claim 1, further containing an inorganic reinforcing material ranged from 0.01% by weight to 40% by weight.
